(19) United States
(12) Patent Application Publication
(10) Pub. No.: US 2026/0360111 A1
(43) Pub. Date: Nov. 12, 2026

(54) CLASSIFYING IMAGES USING CONTEXT DATA

(71) Applicant: Cisco Technology, Inc., San Jose, CA (US)

(72) Inventors: Suresh Gopathy, Alpharetta, GA (US); Gajendar Pandey, u, Karnataka (IN)

(21) Appl. No.: 19/199,561

(22) Filed: May 6, 2025

(51) Int. Cl. G06V 10/764; H04L 9/40

(52) U.S. Cl. CPC G06V 10/764; H04L 63/20; G06V 2201/10

(57) ABSTRACT

Techniques provide a context image scanner that is multi-layered and configured to utilize context data of an image to improve detections and accuracy of classifications of images. The context image scanner can leverage social media, websites and internet context to accurately tag an image as inappropriate or insensitive. The context image scanner may then use the tag to block inappropriate or sensitive images across different applications of the network (e.g., email, chat, etc.). Accordingly, the techniques may provide a more accurate and less resource intensive way to detect and classify sensitive or harmful images, reducing the number of false positives reported and improving security of the network.

### TECHNICAL FIELD

The present disclosure relates generally to the field of network security, and more particularly to detecting and classifying images using an image scanner.

### BACKGROUND

Security solutions, such as secure email gateways (SEGs), secure web gateway(s) (SWGs), and more utilize image scanners in order to detect and filter out inappropriate or sensitive images. For instance, solutions to detect inappropriate or sensitive images may use Computer Vision (CV) and Optical Character Recognition (OCR). These solutions identify objects, scenes, actions and texts present in the images and correlate them to categorize image into nudity, violence, racism, weapon etc.

However, existing solutions can be inaccurate, resulting in high volumes of false positive detections of images and/or incorrect classifications. Thus, harmful or malicious images may be allowed, while benign images are flagged. Further, incorrect classifications and high volumes of false positives reduces scalability of existing techniques.

Accordingly, there is a need for a scalable way to improve both the accuracy of detection and classification of images by image scanners.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a system can implement a context image scanner (CIS), as described herein.

FIG. 2 illustrates a component diagram of an example CIS, according to the techniques described herein.

FIG. 3A illustrates an example system for utilizing a CIS, according to the techniques described herein.

FIG. 3B illustrates an example system for utilizing a CIS, according to the techniques described herein.

FIG. 4A illustrates a flow diagram of an example method for identifying tag(s) and image data in memory, according to the techniques described herein.

FIG. 4B illustrates a flow diagram of an example method for detecting and classifying image(s) using context data, according to the techniques described herein.

FIG. 5 illustrates a flow diagram of an example system for providing a multi-layer context image scanner, according to the techniques described herein.

FIG. 6 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of network security, and more particularly to detecting and classifying images using context data. For instance, the present disclosure describes utilizing a multi-layer context image scanner within a network.

A method to perform the techniques described herein may include receiving, by an image scanner, an image received by an application within a network. The method may include determining, by the image scanner, context data including first metadata associated with the image. The method may also include generating, by the image scanner and based on the context data, second metadata associated with the image. The method further comprises generating, by the image scanner and based on the first metadata and the second metadata, textual data associated with the image. The method may comprise determining, by the image scanner and based on the context data, the second metadata, and textual data, a judgement including at least one classification of the image. The method further comprises performing an action based at least in part on the judgement.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### Example Embodiments

Security solutions, such as secure email gateways (SEGs), secure web gateway(s) (SWGs), and more utilize image scanners in order to detect and filter out inappropriate or sensitive images. For instance, solutions to detect inappropriate or sensitive images may use Computer Vision (CV) and Optical Character Recognition (OCR). These solutions identify objects, scenes, actions and texts present in the images and correlate them to categorize image into nudity, violence, racism, weapon etc.

However, existing image scanners rely heavily on image recognition and keyword filtering and lack contextual awareness in terms of how such images are used and interpreted on social media and in internet, resulting in existing techniques being unable to keep up with evolving trends like internet culture, memes and slang to interpret new forms of potentially offensive images. For example, a meme which might appear humorous at first glance can carry deeper, more harmful connotations depending on the context in which they're being shared and/or discussed on social media. Examples include an image with text that on their own are harmless, but with context, include inappropriate innuendo and/or content (e.g., racism, adult innuendo, etc.). In these cases, existing solutions may not classify the image as inappropriate, resulting in the image being sent via a network. Thus, existing solutions often miss and/or incorrectly classify images, resulting in potentially malicious or harmful images being allowed through a network.

Further, existing solutions may flag the image as belonging to other possible classifications based on the image itself (e.g., whether there is a tree in the image, a person, an animal, etc.), such that the image is included in multiple classifications that are incorrect. This can result in a high volume of false positives and low accuracy of the techniques, thereby reducing scalability of the solutions.

Accordingly, there is a need for a way to improved accuracy of image scanners in a scalable way.

This disclosure describes techniques and mechanisms for a system to detect and classify images using context data. In some examples, the system may be performed by a context image scanner. The system may receive, by an image scanner, an image received by an application within a network. The system may determine, by the image scanner, context data including first metadata associated with the image. The system may also generate, by the image scanner and based on the context data, second metadata associated with the image. The system may also generate, by the image scanner and based on the first metadata and the second metadata, textual data associated with the image. The system may determine, by the image scanner and based on the context data, the second metadata, and textual data, a judgement including at least one classification of the image. The system may perform an action based at least in part on the judgement.

In some examples, the techniques of the system may be performed by a context image scanner (CIS). The CIS may be implemented as part of a service (e.g., such as a chat or message service, firewall service, email service, etc.) provided by a service provider (e.g., such as Cisco). The service may include a cloud service and/or a service running on network device(s) of a network. In some examples, the CIS 106 may be included as part of a firewall service (e.g., such as Cisco's Secure Email Gateway), a chat service (e.g., such as Cisco's Webex) and/or any other service that utilizes an image scanner. In some examples, the CIS 106 may be implemented as one or more of a cloud service, within an enterprise network, and/or running on hardware of network device(s).

In some examples, the system may comprise a memory component. In some examples, the memory component may be configured to tag and store image(s) and metadata associated with the image(s). In some examples, the memory component may comprise an application programming interface (API) configured to interface with a datastore. The datastore may comprise persistent memory and/or cache memory. The memory component may be configured to access the datastore in response to receiving an image as input to the CIS. The memory component may determine whether the image and metadata is stored in the datastore, such that the image has already been classified and/or categorized as inappropriate or sensitive by the CIS. Where the memory component determines the image is not stored in the datastore, the system may utilize contextual metadata component. Where the memory component determines that the image is stored in the datastore, the memory component may determine whether the memory has expired (e.g., that a period of time associated with the cache memory has expired). If the memory has expired, the memory component may clear the cache and the system may proceed to utilizing the contextual metadata component. Where the memory has not expired, the system may retrieve the metadata associated with the image, included the classification(s) and/or categorization(s) the image is tagged with, and provide the metadata and image to the action component.

In some examples, such as where the memory has expired and/or the image is not included in the datastore, the memory component may receive input from the action component and/or judgement component that includes an image and metadata (e.g., classification(s), categorization(s), etc.). The memory component may tag the image according to the classification(s) and categorization(s) and store the image and associated metadata in the datastore. For instance, the memory component may receive the image and metadata in response to the system determining a judgement (e.g., such as an image is inappropriate, comprises adult content, comprises a particular score of a particular category of content, etc.). For instance, the memory component may tag an image as comprising appropriate and/or safe content. The memory component may tag another image as comprising inappropriate content associated with an adult classification. In some examples, the judgement(s) may comprise image data, including tag(s) associated with the image and/or metadata associated with the image. As described herein, the tag(s) may comprise one or more categorization(s) and/or classification(s) of the image. In some examples, the tag(s) may further indicate a score associated with each categorization and/or classification. For instance, where an image is categorized as “sensitive” and classified as comprising “adult” content, the system may further indicate a score (e.g., ranging from 0-5 or any other suitable scale) that indicates a level of the “adult” content the image contains. For instance, an image comprising a tree with suggestive text may be classified as “adult” with a score that is different from an image comprising humans with the same suggestive text.

In some examples, the system may comprise a contextual metadata component. In some examples, the contextual metadata component may be configured to perform a reverse image search of an image received by the CIS. For instance, the contextual metadata component may perform the reverse image search by searching websites and social media sites for the presence of the image and storing the corresponding website(s) and/or URLs. The contextual metadata component may be configured to perform a loop where, for each website and/or URL, the contextual metadata component may: (1) perform web categorization to categorize content data of the website or URL and/or sub-categorizations associated with the website or URL; (2) perform metadata collection by capturing metadata (e.g., Caption and alt text in the image, Hashtags associated with the image, User's comments and reactions to the image, Extract info about platform, communities where the images are shared/used, Extract info pertaining to current events/news associated with the image) associated with the image on the website or URL; (3) perform cross-platform correlation by comparing how the image is being shared across different social media platforms and/or websites and in what context, as well as identifying indications of misuse of the image; and/or (4) determining whether the website or URL includes platform context moderation flags by determining if the image has been flagged, reported, removed and/or what level of moderation is used by the website or URL. In some examples, the contextual metadata component may be configured to utilize a web crawler and/or other service(s) of the service provider to perform the functionalities.

In some examples, the system may comprise an image and text analysis component. In some examples, the image and text analysis component may comprise separate elements. For instance, the system may comprise an image analysis component and/or a text analysis component. The image analysis component may be configured to perform computer vision and/or deep learning on the image in order to generate image metadata (e.g., extract visual features, identify object(s), face(s), and/or other key element(s)). Additionally, or alternatively, the image analysis component may perform optical character recognition (OCR) on the image to generate the image metadata (e.g., detect and extract text embedded in the image).

In some examples, the text analysis component may be configured to perform text analysis on the image. For instance, the text analysis component may be configured to receive the contextual metadata from the contextual metadata component and image metadata from the image analysis component as inputs. The text analysis component may perform natural language processing (NLP) on the inputs and may generate text metadata. For instance, the text metadata may indicate determined themes and/or sentiments (e.g., how the image is being used on the website(s) or social media platform(s) (e.g., in an inappropriate manner, to harass or harm, to support, etc.), how users react to the image (negatively, positively, etc.), intent (e.g., malicious, benign, etc.) of how the image is used) associated with the image.

In some examples, the system may comprise a judgement component. The judgement component may be configured to receive the contextual metadata, image metadata, and text metadata as inputs. The judgement component may be configured to aggregate the metadata and generate a judgement that includes one or more classification(s) of the image. In some examples, the judgement component may generate the judgement using one or more machine learning model(s) that are specialized in correlating set(s) of inputs and trained for accuracy of classification(s) and detection of image(s) based on context. As noted above, the judgement(s) may comprise tag(s) and/or score(s). In some examples, the machine learning model(s) may comprise a large language model (LLM) trained using historical metadata and/or user feedback. In some examples, the system may refine the machine learning model(s) based on new social trends, user feedback, emergence of new meme(s) and/or type(s) of memes, slang terms, etc. In some examples, the judgement component may generate the judgement using a static set of rules that may be dynamically updated and/or pushed to the CIS (e.g., such as from the service provider). The judgement component may generate and provide the judgement associated with the image as output to the action component.

In some examples, the system may comprise an action component. The action component may be configured to identify and apply a policy to the message based on the judgement. For instance, the action component may determine a security policy associated with the service and may apply the appropriate action (e.g., such as drop the message, strip image, etc.) to the message. In some examples, the action may be determined based on a score included in a judgement and/or the policy. For instance, the policy may indicate that a particular action (e.g., drop the message) be taken where a particular classification of an image is determined and/or the classification comprises a score above a threshold score (e.g., classification of “adult” that comprises a score greater than or equal to “3”). In some examples, the security policy may be stored in memory of the service and accessible to the action component. In some examples, the action component may be implemented as part of a security actor (e.g., web policy gateway, firewall policy application, etc.) of the service. In some examples, the action component may be integrated as part of the CIS. In some examples, the action component and/or judgement component may send the judgement and/or action(s) to the memory component to enable the memory component to store and tag the image in memory of the CIS and/or the service.

In some examples, the system may be configured to process a plurality of images in parallel. For instance, the system may be configured to scale based on hardware and processing capabilities of a network device. The system may also be configured to provide judgement(s) to request(s) (from different application(s) and/or the same application(s)) independent from one another. Thus, the previous image received by the CIS does not impact the judgement of the subsequent image(s). Moreover, by tagging and storing image(s) in memory, the system may enable policies to be applied to inappropriate and/or sensitive image(s) across application(s) and security products and in real-time.

In this way, the system may provide a multi-layered contextual image scanner (CIS) that integrates images recognition with social media websites and internet context. By utilizing context, the system may improve accuracy of image categorization(s) and classification(s), leading to a reduction in false positive(s) across different categories (e.g., malicious, benign, etc.) and/or classification(s) (e.g., adult, spoof, medical, violence, racial, etc.). Further, by reducing false positive(s) (e.g., categorizing an image as malicious or harmful when it may not be) and reducing incorrect classification(s), the system may improve the amount of true positive(s) that are identified. Further, given the system may be integrated and deployed as part of a cloud service, within an enterprise network, and/or run on hardware of a network device, the system is highly scalable and may be implemented by any service that utilizes an image scanner. The system may reduce computing resources required by reducing false positives, thereby enabling traditional image categories and/or classification(s) to extend and/or include additional categories.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

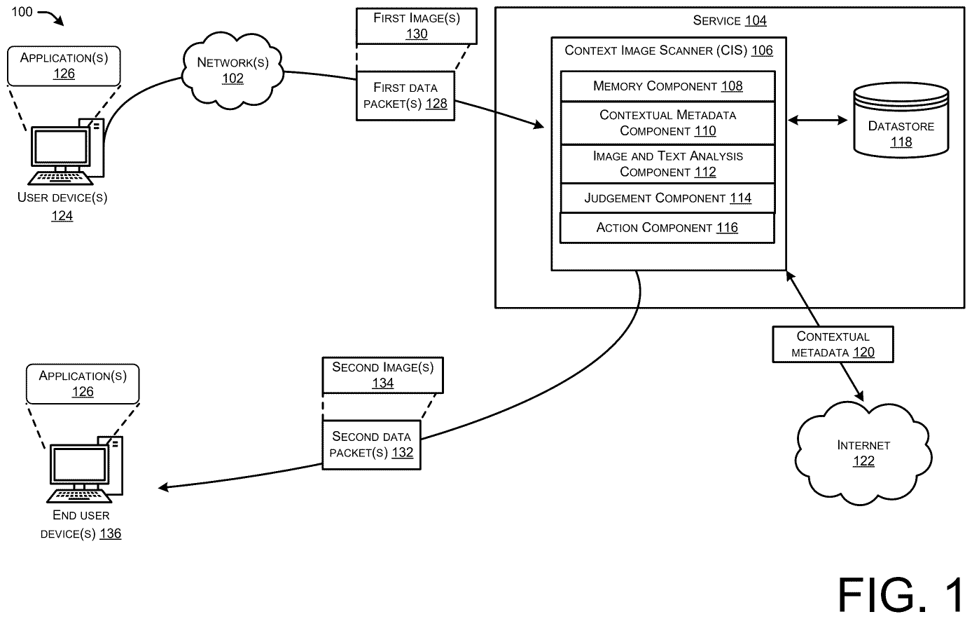

FIG. 1 illustrates a system-architecture diagram of an environment in which a system 100 can implement a context image scanner (CIS), as described herein. While the system 100 shows an example CIS 106 being implemented by a service 104, it is understood that any of the components of the system 100 may be implemented on any device in the system 100. Further, the example CIS 106 and/or datastore 118 may be implemented separately from the service 104.

In some examples, the system 100 may include network(s) 102. The network(s) 102 may include one or more networks implemented by any viable communication technology, such as wired and/or wireless modalities and/or technologies. The network(s) 102 may include any combination of a service network, Personal Area Networks (PANs), SDCI, Local Area Networks (LANs), virtual LANs, Campus Area Networks (CANs), Metropolitan Area Networks (MANs), extranets, intranets, the Internet, short-range wireless communication networks (e.g., ZigBee, Bluetooth, etc.), RA VPNs, VPNs, ZTNA, Wide Area Networks (WANs)-both centralized and/or distributed-and/or any combination, permutation, and/or aggregation thereof. The network(s) 102 may include devices, virtual resources, or other nodes that relay packets from one network segment to another by nodes in the computer network. The network(s) 102 may include multiple devices that utilize the network layer (and/or session layer, transport layer, etc.) in the OSI model for packet forwarding, and/or other layers.

The system 100 may comprise a service 104, which may be implemented by one or more computing device(s). For instance, the service 104 may be implemented by one or more site(s). In some examples, the service 104 may be implemented by user computing device(s) (e.g., such as user device(s) 124 and/or end user device(s) 136).

In some examples, the site(s) may comprise one or more server(s), enterprise network(s) and/or service(s) associated with a service provider (e.g., such as Cisco), one or more network device(s), etc. In some examples, the site(s) correspond to one or more data center(s) comprising various network components, such as, for example, network switch(es) (also referred to as node(s)) operating on physical servers. In some examples, the site(s) may comprise physical server(s) that may host one or more virtual machines. Each virtual machine may be configured to execute one of various operations and act as one or more virtual components for the cloud network(s) and/or enterprise/application network, such as, for example, application(s). In some examples, the physical server(s) may host any number of virtual machines. In some examples, the physical server(s) in the enterprise/application network may host the various network components of the enterprise/application network. In some examples, the user device(s) comprise one or more user(s), mobile device(s), and/or Internet of Things (IOT) device(s) located at one or more locations.

As noted above, the service 104 may be running on one or more network device(s). The network device(s) may comprise routers, switches, access points, stations, radios, or any other network device.

The system 100 may comprise a CIS 106. In some examples, the CIS 106 may be integrated as part of a service 104 running on a service provider (e.g., such as Cisco) and/or may run on hardware of network device(s). For instance, the service 104 may correspond to a firewall service, an email service, a SEG, a SWG, etc. As an example, the service 104 may be configured to receiving first data packet(s) 128, which may comprise first image(s) 130. In some examples, the first data packet(s) 128 may further comprise text data, attachment(s) (e.g., PDFs, documents, etc.) emoji's, GIFs, etc. Where the service 104 comprises a SEG, the first data packet(s) 128 may correspond to email message(s) sent from user device(s) 124 to end user device(s) 136. First data packet(s) 128 may further correspond to chat message(s) and/or any other data packet or message that can include image(s). In some examples, application(s) 126 may correspond to application(s) that utilize service 104. For instance, application(s) 126 may comprise an email application, a chat application, a video conference application, or any other type of application that may implement an image scanner.

In some examples, the CIS 106 may be implemented on one or more network device(s) and/or at the service provider. The CIS 106 may correspond to a system that has complete visibility into the fabric of a given network (e.g., enterprise network, local network, etc.) and may be configured to monitor traffic flow within the network(s) 102.

The CIS 106 may include a memory component 108. In some examples, the memory component may be configured to tag and store image(s) and metadata associated with the image(s). In some examples, the memory component may comprise an application programming interface (API) configured to interface with a datastore 118. The datastore 118 may comprise persistent memory and/or cache memory. In some examples, the datastore 118 is integrated as part of the CIS 106. In some examples, the datastore 118 is included as part of the service 104. The memory component 108 may be configured to access the datastore 118 in response to receiving an image as input to the CIS. The memory component 108 may determine whether the image and metadata is stored in the datastore 118, such that the image has already been classified and/or categorized as inappropriate or sensitive by the CIS. Where the memory component determines the image is not stored in the datastore 118, the system may utilize contextual metadata component to generate contextual metadata 120. Where the memory component determines that the image is stored in the datastore, the memory component may determine whether the memory has expired (e.g., that a period of time associated with the cache memory has expired or elapsed). If the memory has expired, the memory component may clear the cache and the system may proceed to utilizing the contextual metadata component. Where the memory has not expired, the system may retrieve the metadata associated with the image, included the classification(s) and/or categorization(s) the image is tagged with, and provide the metadata and image to the action component.

In some examples, such as where (1) the memory (or tag) has expired and the system has removed the tag from memory or cleared the memory, and/or (2) the image is not included in the datastore, the memory component may receive input from the action component and/or judgement component that includes an image and image metadata (e.g., tag(s), judgement, including classification(s), categorization(s), etc.). The memory component may tag the image according to the classification(s) and categorization(s) and store the image and associated image metadata in the datastore. For instance, the memory component may receive the image and metadata in response to the system determining a judgement (e.g., such as an image is inappropriate, comprises adult content, comprises a particular level of a particular category of content, etc.). For instance, the memory component may tag an image as comprising appropriate and/or safe content. The memory component may tag another image as comprising inappropriate content associated with an adult classification. Accordingly, when the system receives the same image as input from application(s) 126 and/or a different application, the system may utilize the memory component to apply tag(s) across application(s) of the network 102 and perform action(s) in real-time based on policies.

The CIS 106 may include a contextual metadata component 110. In some examples, the contextual metadata component may be configured to generate contextual metadata 120. For instance, the contextual metadata component 110 may perform a reverse image search of an image received by the CIS 106, such as via internet 122. For instance, the contextual metadata component 110 may perform the reverse image search by searching websites and social media sites for the presence of the image and storing the corresponding website(s) and/or URLs. The contextual metadata component may be configured to perform a loop where, for each website and/or URL, the contextual metadata component may: (1) perform web categorization to categorize content data of the website or URL and/or sub-categorizations associated with the website or URL; (2) perform metadata collection by capturing metadata (e.g., caption(s) and alternative text in the image, hashtag(s) associated with the image, user comments and reactions to the image, extracting information about platform, communities where the images are shared/used, extracting information pertaining to current events/news associated with the image) associated with the image on the website or URL; (3) perform cross-platform correlation by comparing how the image is being shared across different social media platforms and/or websites and in what context, as well as identifying indications of misuse of the image; and/or (4) determining whether the website or URL includes platform context moderation flags by determining if the image has been flagged, reported, removed and/or what level of moderation is used by the website or URL. In some examples, the contextual metadata component may be configured to utilize a web crawler and/or other service(s) of the service provider to perform the functionalities. In some examples, the contextual metadata 120 may comprise an aggregation of the data and/or metadata returned from the reverse image search and/or from performing the loop.

In some examples, the image and text analysis component 112 may comprise separate elements. For instance, the system may comprise an image analysis component and/or a text analysis component. The image analysis component may be configured to perform computer vision and/or deep learning on the image in order to generate image metadata (e.g., extract visual features, identify object(s), face(s), and/or other key element(s)). Additionally, or alternatively, the image analysis component may perform optical character recognition (OCR) on the image to generate the image metadata (e.g., detect and extract text embedded in the image).

In some examples, the text analysis component may be configured to perform text analysis on the image. For instance, the text analysis component may be configured to receive the contextual metadata from the contextual metadata component and image metadata from the image analysis component as inputs. The text analysis component may perform natural language processing (NLP) on the inputs and may generate text metadata. For instance, the text metadata may indicate determined themes and/or sentiments (e.g., how the image is being used on the website(s) or social media platform(s) (e.g., in an inappropriate manner, to harass or harm, to support, etc.), how users react to the image (negatively, positively, etc.), intent (e.g., malicious, benign, etc.) of how the image is used) associated with the image.

In some examples, the system may comprise a judgement component 114. The judgement component 114 may be configured to receive the contextual metadata, image metadata, and text metadata as inputs. The judgement component 114 may be configured to aggregate the metadata and generate a judgement that includes one or more classification(s) of the image. In some examples, the judgement component may generate the judgement using one or more machine learning model(s) that are specialized in correlating set(s) of inputs and trained for accuracy of classification(s) and detection of image(s) based on context. In some examples, the machine learning model(s) may comprise a large language model (LLM) trained using historical metadata and/or user feedback. In some examples, the system may refine the machine learning model(s) based on new social trends, user feedback, emergence of new meme(s) and/or type(s) of memes, slang terms, etc. In some examples, the judgement component may generate the judgement using a static set of rules that may be dynamically updated and/or pushed to the CIS (e.g., such as from the service provider). The judgement component may generate and provide the judgement associated with the image as output to the action component. 116

In some examples, the system may comprise an action component 116. The action component 116 may be configured to identify and apply a policy to the message based on the judgement. For instance, the action component 116 may determine a security policy associated with the service and may apply the appropriate action (e.g., such as drop the message, strip image, etc.) to the message. Accordingly, the action component 116 may apply the security policy to the first data packet(s) 128, such that the second data packet(s) 132 may be sent to the end user device(s) 136. In some examples, the second data packet(s) 132 may comprise second image(s) 134 that have been approved based on the policy applied by the action component. For instance, the second image(s) 134 may comprise one or more of the first image(s) 130 that are determined to be non-malicious and/or comprise approved content. In some examples, the second data packet(s) 132 may comprise a message that has been stripped (e.g., image has been removed and/or features of the image censored).

In some examples, the security policy may be stored in memory of the service and accessible to the action component 116. In some examples, the action component 116 may be implemented as part of a security actor (e.g., web policy gateway, firewall policy application, etc.) of the service. In some examples, the action component may be integrated as part of the CIS. In some examples, the action component and/or judgement component may send the judgement and/or action(s) to the memory component to enable the memory component to store and tag the image in memory of the CIS 106 and/or the service 104.

For example, an image may be tagged as containing sensitive subject matter and classified as relating to medical content and/or adult content. In some examples, the medical content may further comprise a score of 3, whereas the adult content score may be 2. A first application utilizing the service 104 may have a configured policy indicating that images categorized as sensitive and classified as adult (e.g., with any score above a 0) gets stripped. In this example, the action component 116 may perform the action to strip the image from the message based on the policy. Similarly, a second application may include a configured policy indicating to block or strip images that are classified as adult and have a score greater than or equal to 3. In this example, the same image may be sent to the second application, however, the action component 116 may allow the image to be sent to the end user device(s) 136. Accordingly, the system may be configured to apply different action(s) to the same image based on tag(s) indicated by the judgement(s) and policies.

In some examples, the system may be configured to process a plurality of images in parallel. For instance, the system may be configured to scale based on hardware and processing capabilities of a network device. The system may also be configured to provide judgement(s) to request(s) (from different application(s) and/or the same application(s)) independent from one another. Thus, the previous image received by the CIS does not impact the judgement of the subsequent image(s). Moreover, by tagging and storing image(s) in memory, the system may enable policies to be applied to inappropriate and/or sensitive image(s) across application(s) and security products and in real-time.

In some examples, one or more of the functionalities of the CIS 106 may be performed in tandem with or independently of each other. For instance, the functionality of the memory component 108, contextual metadata component 110, image and text analysis component 112, judgement component 114, and/or action component 116.

In this way, the system may provide a multi-layered contextual image scanner (CIS) that integrates images recognition with social media websites and internet context. By utilizing context, the system may improve accuracy of image categorization(s) and classification(s), leading to a reduction in false positive(s) across different categories (e.g., malicious, benign, etc.) and/or classification(s) (e.g., adult, spoof, medical, violence, racial, etc.). Further, by reducing false positive(s) (e.g., categorizing an image as malicious or harmful when it may not be) and reducing incorrect classification(s), the system may improve the amount of true positive(s) that are identified. Further, given the system may be integrated and deployed as part of a cloud service, within an enterprise network, and/or run on hardware of a network device, the system is highly scalable and may be implemented by any service that utilizes an image scanner. The system may reduce computing resources required by reducing false positives, thereby enabling traditional image categories and/or classification(s) to extend and/or include additional categories.

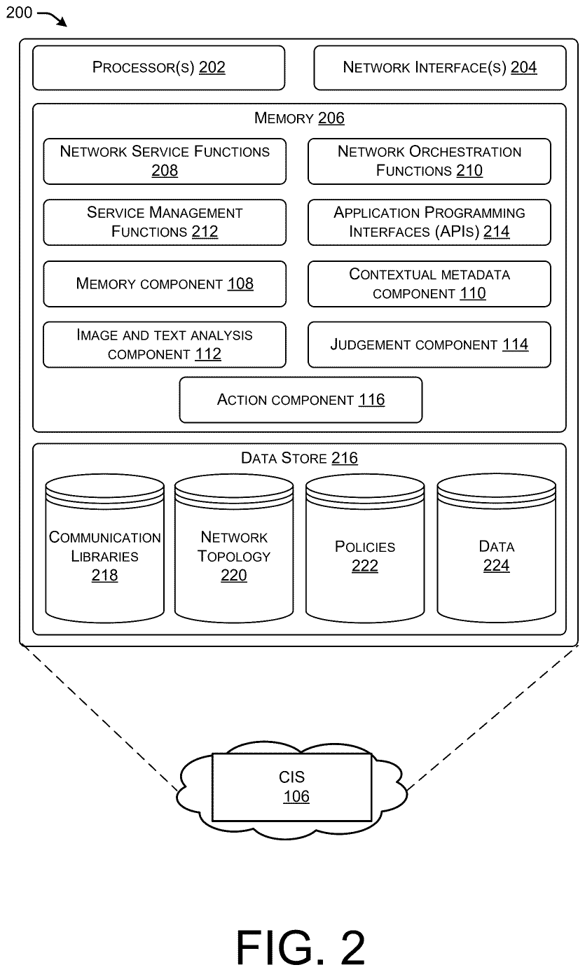

FIG. 2 illustrates a component diagram 200 of an example CIS 106, as described herein. In some instances, the CIS 106 may run on one or more computing devices in, or associated with, the network 102 (e.g., a single device or a system of devices). In some instances, the CIS 106 may be integrated as part of a service 104 (e.g., such as Cisco's Secure Firewall Service). In some examples, the CIS 106 may be run on network device(s) and/or as part of services offered by a service provider. In some examples, one or more of the component(s) of the CIS 106 may be implemented by the network device(s) and/or service provider, however, fewer or additional components may also be used.

Generally, the CIS 106 may include a programmable controller that manages some or all of the controller activities of the network 102, and manages or monitors the network state using one or more centralized control models.

As illustrated, the CIS 106 may include, or run on, one or more hardware processors 202 (processors), one or more devices, configured to execute one or more stored instructions. The processor(s) 202 may comprise one or more cores. Further, the CIS 106 may include or be associated with (e.g., communicatively coupled to) one or more network interfaces 204 configured to provide communications with network device(s), edge device(s) and other devices, and/or other systems or devices in the network 102 and/or remote from the network 102. The network interfaces 204 may include devices configured to couple to personal area networks (PANs), wired and wireless local area networks (LANs), wired and wireless wide area networks (WANs), SDCI's, and so forth. For example, the network interfaces 204 may include devices compatible with any networking protocol.

The CIS 106 may also include memory 206, such as computer-readable media, that stores various executable components (e.g., software-based components, firmware-based components, etc.). The memory 206 may generally store components to implement functionality described herein as being performed by the CIS 106. The memory 206 may store one or more network service functions 208, such as a slicing manager, a topology manager to manage a topology of the network 102, a host tracker to track what network components are hosting which programs or software, a switch manager to manage switches of the network 102, a process manager, and/or any other type of function performed by the CIS 106.

The CIS 106 may further include network orchestration functions 210 stored in memory 206 that perform various network functions, such as resource management, creating and managing network overlays, programmable APIs, provisioning or deploying applications, software, or code to hosts, and/or perform any other orchestration functions. Further, the memory 206 may store one or more service management functions 212 configured to manage the specific services of the network 102 (configurable), and one or more APIs 214 for communicating with devices in the network 102 and causing various controller functions to occur.

In some examples, the CIS 106 may include a memory component 108. As described herein, the memory component 108 may be configured to tag and store image(s) and metadata associated with the image(s). In some examples, the memory component may comprise an application programming interface (API) configured to interface with a datastore 216. The memory component 108 may determine whether the image and metadata is stored in the datastore, such that the image has already been classified and/or categorized as inappropriate or sensitive by the CIS. Where the memory component determines the image is not stored in the datastore, the system may utilize contextual metadata component. Where the memory component determines that the image is stored in the datastore, the memory component may determine whether the memory has expired (e.g., that a period of time associated with the cache memory has expired). If the memory has expired, the memory component may clear the cache and the system may proceed to utilizing the contextual metadata component. Where the memory has not expired, the system may retrieve the metadata associated with the image, included the classification(s) and/or categorization(s) the image is tagged with, and provide the metadata and image to the action component.

In some examples, such as where the memory has expired and/or the image is not included in the datastore, the memory component may receive input from the action component and/or judgement component that includes an image and metadata (e.g., classification(s), categorization(s), etc.). The memory component may tag the image according to the classification(s) and categorization(s) and store the image and associated metadata in the datastore. For instance, the memory component may receive the image and metadata in response to the system determining a judgement (e.g., such as an image is inappropriate, comprises adult content, comprises a particular level of a particular category of content, etc.). For instance, the memory component may tag an image as comprising appropriate and/or safe content. The memory component may tag another image as comprising inappropriate content associated with an adult classification.

In some examples, the CIS 106 may comprise a contextual metadata component 110. In some examples, the contextual metadata component may be configured to perform a reverse image search of an image received by the CIS. For instance, the contextual metadata component may perform the reverse image search by searching websites and social media sites for the presence of the image and storing the corresponding website(s) and/or URLs. The contextual metadata component may be configured to perform a loop where, for each website and/or URL, the contextual metadata component may: (1) perform web categorization to categorize content data of the website or URL and/or sub-categorizations associated with the website or URL; (2) perform metadata collection by capturing metadata (e.g., Caption metadata and alternative text in the image, Hashtags associated with the image, User's comments and reactions to the image, Extract info about platform, communities where the images are shared/used, Extract info pertaining to current events/news associated with the image) associated with the image on the website or URL; (3) perform cross-platform correlation by comparing how the image is being shared across different social media platforms and/or websites and in what context, as well as identifying indications of misuse of the image; and/or (4) determining whether the website or URL includes platform context moderation flags by determining if the image has been flagged, reported, removed and/or what level of moderation is used by the website or URL. In some examples, the contextual metadata component may be configured to utilize a web crawler and/or other service(s) of the service provider to perform the functionalities.

In some examples, the CIS 106 may include an image and text analysis component 112. In some examples, the image and text analysis component may comprise separate elements. For instance, the system may comprise an image analysis component and/or a text analysis component. The image analysis component may be configured to perform computer vision and/or deep learning on the image in order to generate image metadata (e.g., extract visual features, identify object(s), face(s), and/or other key element(s)). Additionally, or alternatively, the image analysis component may perform optical character recognition (OCR) on the image to generate the image metadata (e.g., detect and extract text embedded in the image).

In some examples, the text analysis component may be configured to perform text analysis on the image. For instance, the text analysis component may be configured to receive the contextual metadata from the contextual metadata component and image metadata from the image analysis component as inputs. The text analysis component may perform natural language processing (NLP) on the inputs and may generate text metadata. For instance, the text metadata may indicate determined themes and/or sentiments (e.g., how the image is being used on the website(s) or social media platform(s) (e.g., in an inappropriate manner, to harass or harm, to support, etc.), how users react to the image (negatively, positively, etc.), intent (e.g., malicious, benign, etc.) of how the image is used) associated with the image.

In some examples, the CIS 106 may include a judgement component 114. The judgement component may be configured to receive the contextual metadata, image metadata, and text metadata as inputs. The judgement component may be configured to aggregate the metadata and generate a judgement that includes one or more classification(s) of the image. In some examples, the judgement component may generate the judgement using one or more machine learning model(s) that are specialized in correlating set(s) of inputs and trained for accuracy of classification(s) and detection of image(s) based on context. In some examples, the machine learning model(s) may comprise a large language model (LLM) trained using historical metadata and/or user feedback. In some examples, the system may refine the machine learning model(s) based on new social trends, user feedback, emergence of new meme(s) and/or type(s) of memes, slang terms, etc. In some examples, the judgement component may generate the judgement using a static set of rules that may be dynamically updated and/or pushed to the CIS (e.g., such as from the service provider). The judgement component may generate and provide the judgement associated with the image as output to the action component.

In some examples, the judgement component 114 may utilize one or more machine learned model(s) (e.g., such as LLMs) to generate the judgements. In some examples, the artificial intelligence models are pre-trained using machine learning techniques. In some examples, the CIS 106 and/or service 104 may store machine-trained data models for use during operation. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

In some examples, the models may be updated and/or re-trained in real-time. For instance, the CIS 106 and/or judgement component 114 may update the one or more machine learning models based on identification of new context data and/or metadata, outputs from the machine learning models, user feedback, etc.

In some examples, the CIS 106 may include an action component 116. The action component may be configured to identify and apply a policy to the message based on the judgement. For instance, the action component may determine a security policy associated with the service and may apply the appropriate action (e.g., such as drop the message, strip image, etc.) to the message. In some examples, the security policy may be stored in memory of the service and accessible to the action component. In some examples, the action component may be implemented as part of a security actor (e.g., web policy gateway, firewall policy application, etc.) of the service. In some examples, the action component may be integrated as part of the CIS. In some examples, the action component and/or judgement component may send the judgement and/or action(s) to the memory component to enable the memory component to store and tag the image in memory of the CIS and/or the service.

The CIS 106 may further include a datastore 216, such as long-term storage, that stores communication libraries 218 for the different communication protocols that the CIS 106 is configured to use or perform. Additionally, the datastore 216 may include network topology data 220, such as a model representing the layout of the network components in the network 102 and/or data indicating available bandwidth, available CPU, delay between nodes, computing capacity, processor architecture, processor type(s), etc. The datastore 216 may store policies 222 that include security data associated with the network, security policies configured for the network, firewall policies, intrusion prevention policies, firewall configuration data, network configuration policies, network configuration data, security posture data, and/or compliance policies configured for the network. The datastore 216 may store data 224 including data packet data, any of the metadata described herein, contextual metadata, tag data, image(s), classification data, categorization data, and/or any other data, metadata, and/or information described herein.

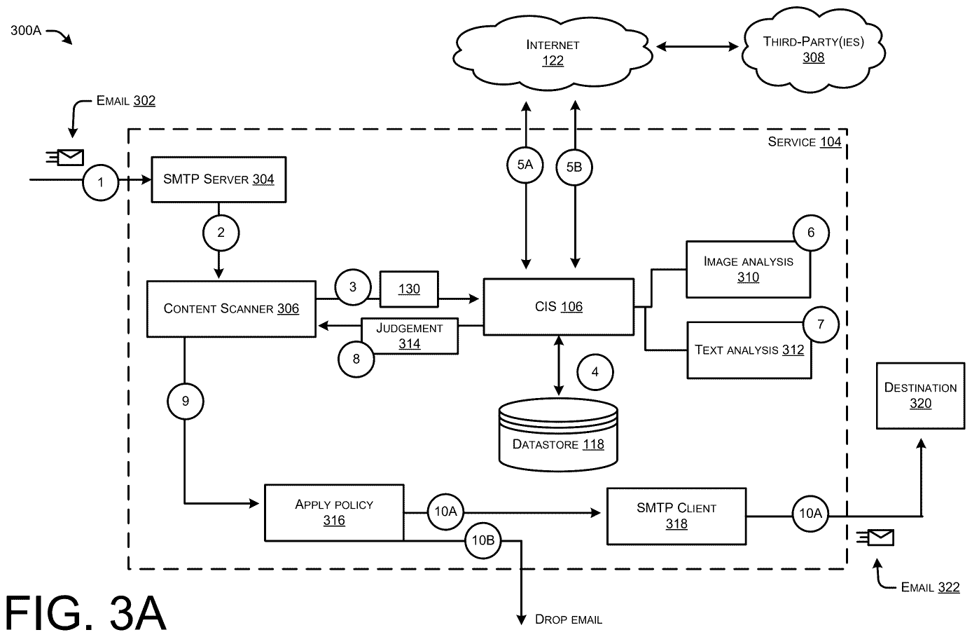

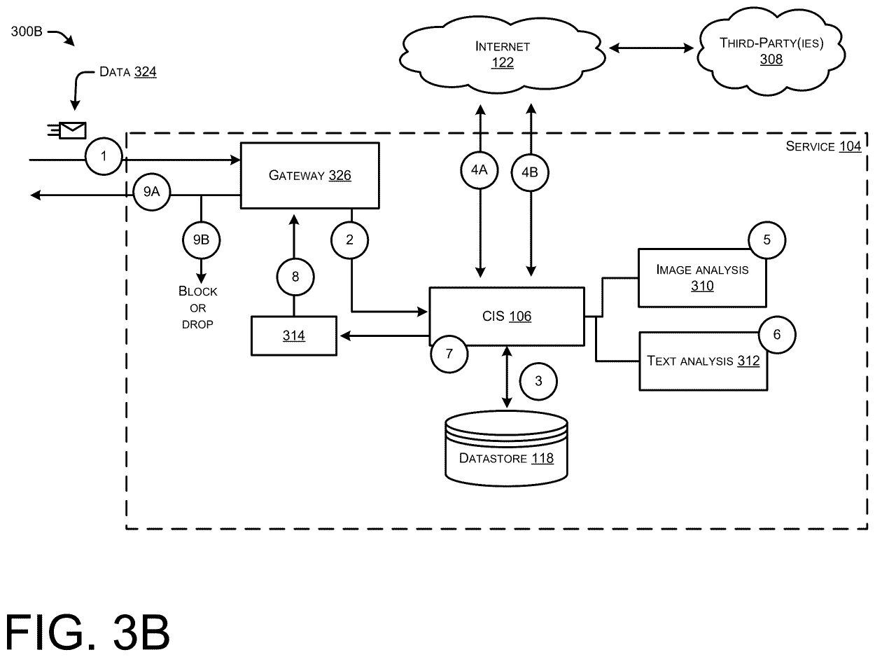

FIG. 3A illustrates an example system 300A for utilizing a CIS 106, according to the techniques described herein. In some instances, one or more of the steps of system 300A may be performed by one or more devices (e.g., CIS 106, service 104, etc.) that include one or more processors and one or more non-transitory computer-readable media storing computer-executable instructions that, when executed by the one or more processors, cause the one or more processors to perform operations of system 300A.

In some examples, the system 300A may correspond to an example where the CIS 106 is implemented as part of a SEG. For instance, the service 104 may comprise an email service. As illustrated the example system 300A may include the service 104, CIS, 106, Internet 122, datastore 118, and first image(s) 130. The system 300A further includes features and/or components associated with the SEG, such as a SMTP server 304, content scanner 306, and SMTP client 318.

At “1”, the SMTP server 304 may receive an email 302 from a user device. At “2”, the SMTP server 304 may send the email to the content scanner 306, which is configured to determine whether the email 302 includes an image (e.g., such as first image(s) 130).

At “3”, where the content scanner 306 determines the email 302 includes the first image(s) 130, the content scanner 306 sends the first image(s) 130 to the CIS 106.

At “4”, the CIS 106 determines whether the image has been previously tagged and/or is stored in the datastore 118 (e.g., such as a cache memory). For instance, the CIS 106 may utilize memory component 108. In some examples, the CIS 106 may be configured to access the datastore 118 via a CIS API (not shown), such that application(s) or component(s) external to the CIS 106 may not access the datastore 118, thereby ensuring security of the image(s) stored and tagged by the CIS 106 and enabling the tag(s) and/or classification(s) to be utilized across application(s) of a network.

Where the CIS 106 determines that the datastore 118 includes the image and/or tag, the CIS 106 may determine whether the memory and/or tag is expired. For instance, the CIS 106 may determine whether a predetermined period of time associated with the tag and/or the cache memory has elapsed. Where the predetermined period of time has not elapsed, the CIS 106 may generate judgement 314 (described in “8” below) based on the tag and/or associated metadata of the image stored in the datastore 118. For instance, the tag may indicate the image is harmful and/or violates a particular policy. Accordingly, the judgement 314 may be generated without the system 300A performing steps 5A-7. Where the predetermined period of time has elapsed, the CIS 106 may determine that the tag and/or memory has expired and may remove the tag and image data from the datastore 118 and/or clear the cache memory and proceed to “5A”.

At “5A”, the CIS 106 may perform, via the internet 122, a reverse image search of the first image 130. For instance, the CIS 106 may utilize the contextual metadata component 110 when performing 5A and 5B. In some examples, the CIS 106 may receive, based on the reverse image search, a set of results including one or more website(s), social media site(s), and/or URLs where the image is being used and/or found.

At “5B”, the CIS 106 may perform a contextual metadata process that loops through each resulting included in the set of results returned in 5A. In some examples, the CIS 106 may utilize web crawling when performing the contextual metadata process. In some examples, the CIS 106 may loop through steps (i)-(iv) for each result and generate contextual metadata comprising the aggregated outputs of the process. The contextual metadata process may include the steps of: (i) performing web categorization; (ii) performing metadata collection; (iii) performing cross-platform correlation; and (iv) determining platform content moderation flag(s). In some examples, the CIS 106 may access one or more third-party(ies) 308 (e.g., website(s), social media platform(s), cloud service(s), etc.) when performing the process.

In some examples, performing web categorization may include categorize the content of the sites where the image was found during reverse image search. In some examples, the CIS 106 may utilize other services of a service provider (e.g., such as Cisco's TALOS, etc.) when performing the web categorization. As an example, a result of the set returned from 5A may include “AMC.com.” The system may perform web categorization to determine one or more categorizations of the image on amc.com. There may be a single categorization or multiple categorizations associated with the image. Examples of different types of categorizations: content categorization (social network; where it is from); threat categorization (not phishing website; not malicious website); URL reputation (good/positive; negative). In some examples, web categorizations may include content categorization associated with a particular social media platform (e.g., such as reddit.com) and one or more sub-web categorizations (e.g., categorization of a specific forum where the image is posted—e.g., adult forum, movie forum, etc.) within the social media platform.

In some examples, performing metadata collection may include capturing metadata information associated with the image on social media and websites. This may include extracting one or more of caption and alternative text in the image, hashtags associated with the image, user comments and/or reactions to the image. Capturing the metadata information may further include extracting information about the platform and/or website, communities where the images are shared/used, extracting information pertaining to current events/news associated with the image. The captured metadata information may be used by the system to determine an overall sentiment associated with the image (e.g., how people are reacting to it; what are the comments? How have people intended to use the image (positive or negatively)?), such as part of text analysis 312.

In some examples, performing cross-platform correlation may include comparing how the same image is being shared across different platforms/websites and in what context. For instance, the system may determine that some metadata associated with the image comes from website A and other metadata is from website B. The system may correlate the metadata, such that the CIS 106 can determine how the image is being used across the different site(s) (e.g., such as when performing text analysis, as described herein).

In some examples, determining platform content moderation flag(s) may include determining if the image has been flagged, reported or removed from any of the result(s). For instance, some platforms or websites may utilize security flags and/or may implement different levels of content moderation. Content moderation used by different services can vary and have different levels. Additionally, some platforms or websites may tag an image according to its own particular set of moderation rules. Thus, tags and/or what content is moderated can differ based on the platform/policies. As an example, “abc.com” may have a very high content moderation policy and/or may provide an alert that may saying “this is a sensitive image, if you want to open it, click on it.” Thus, in this example, the website may provide advanced warning of images or content the website has tagged as “sensitive”. Accordingly, the system can extract and use the metadata including the “verdicts” from different platforms/website(s) to see how different platforms tag and/or classify the image.

At “6”, the CIS 106 may perform image analysis 310 of the image to generate image metadata. Image analysis 310 may comprise one or more of (i) performing Computer Vision (CV) and/or Deep Learning to generate metadata for the image, such as: to extract visual features, identify objects, faces and/or other key elements and/or (ii) performing Optical Character Recognition (OCR) in order to detect and extract text embedded in the image. For instance, the CIS 106 may generate image metadata using image analysis component, as described herein.

At “7”, the CIS 106 may perform text analysis 312 of the image to generate text metadata. Text analysis 312 may comprise applying NLP to the contextual metadata and image metadata in order to generate the text metadata (e.g., identifying sentiments, themes, etc.).

At “8”, the CIS 106 may generate judgement 314. In some examples, the CIS 106 may utilize judgement component 114 to generate judgement 314, as described herein. The judgement 314 may be output to the content scanner 306.

At “9”, the content scanner 306 may receive the judgement 314 and may determine and/or identify whether a policy of the service 104 applies to the email. For instance, the content scanner 306 may determine whether to apply a security policy based on one or more of the categorization(s), classification(s), etc. included in the judgement 314.

At “10A”, the service 104 may apply the policy 316 to the email 302. For instance, the service 104 may strip the email 302 (e.g., remove the image, remove metadata, or other data) and/or may not change the email 302 (e.g., such as where the email is indicated as safe and/or not in violation of the policy 316 to generate email 322. In this example, the email 322 is forwarded to the SMTP client 318 and sent out of the service 104 to destination 320 (e.g., an end user device 136, etc.).

At “10B”, the service 104 may apply a policy 316 resulting in the email 302 being dropped (e.g., not sent and/or blocked from sending). For instance, where the system 300A determines that the tag (e.g., classification(s) and/or categorization(s)) of the image and/or email 302 violates a policy 316, the service 104 may drop the email 302.

In some examples, the CIS 106 may further store the tag(s) associated with the image(s) and generated as part of the judgement(s) 314 in the datastore 118. For instance, the memory component 108 of the CIS 106 may store and/or update the datastore 118 with the tags.

FIG. 3B illustrates an example system 300B for utilizing a CIS 106, according to the techniques described herein. In some instances, one or more of the steps of system 300B may be performed by one or more devices (e.g., CIS 106, service 104, etc.) that include one or more processors and one or more non-transitory computer-readable media storing computer-executable instructions that, when executed by the one or more processors, cause the one or more processors to perform operations of system 300B.

In some examples, the system 300B may correspond to an example where the CIS 106 is implemented as part of a SWG or a chat service. As illustrated, the example system 300B may include the service 104, CIS, 106, Internet 122, third-party(ies) 308, datastore 118, first image(s) 130, image analysis 310, text analysis 312, and policy 316. However, in this example system 300B, the service 104 may include a gateway 326 (or a server, such as a chat server) that is configured to interact with the CIS 106 directly. The gateway 326 (or chat server) may further be configured to access and/or apply policy(ies) of the network and/or service 104 based on the judgement(s) of the CIS 106.

At “1”, the gateway 326 may receive data 324. In some examples, the data 324 may comprise message data (e.g., such as a chat message), transaction data (e.g., such as a user accessing a website), image data, etc.

At “2”, where the gateway 326 identifies image(s) in the data 324, the gateway 326 may provide the image(s) to the CIS 106.

At “3”, the CIS 106 determines whether the image has been previously tagged and/or is stored in the datastore 118 (e.g., such as a cache memory). For instance, the CIS 106 may utilize memory component 108. In some examples, the CIS 106 may be configured to access the datastore 118 via a CIS API (not shown), such that application(s) or component(s) external to the CIS 106 may not access the datastore 118, thereby ensuring security of the image(s) stored and tagged by the CIS 106 and enabling the tag(s) and/or classification(s) to be utilized across application(s) of a network.

Where the CIS 106 determines that the datastore 118 includes the image and/or tag, the CIS 106 may determine whether the memory and/or tag is expired. For instance, the CIS 106 may determine whether a predetermined period of time associated with the tag and/or the cache memory has elapsed. Where the predetermined period of time has not elapsed, the CIS 106 may generate judgement 314 (e.g., such as by using judgement component 114) based on the tag and/or associated metadata of the image stored in the datastore 118. For instance, the tag may indicate the image is harmful and/or violates a particular policy. Accordingly, the judgement may be generated without the system 300B performing steps 4A-6. Where the predetermined period of time has elapsed, the CIS 106 may determine that the tag and/or memory has expired and may remove the tag and image data from the datastore 118 and/or clear the cache memory and proceed to “4A”.

At “4A”, the CIS 106 may perform, via the internet 122, a reverse image search of the first image 130. For instance, the CIS 106 may utilize the contextual metadata component 110 when performing 5A and 5B. In some examples, the CIS 106 may receive, based on the reverse image search, a set of results including one or more website(s), social media site(s), and/or URLs where the image is being used and/or found.

At “4B”, the CIS 106 may perform a contextual metadata process that loops through each resulting included in the set of results returned in 5A. In some examples, the CIS 106 may utilize web crawling when performing the contextual metadata process. In some examples, the CIS 106 may loop through steps (i)-(iv) for each result and generate contextual metadata comprising the aggregated outputs of the process. The contextual metadata process may include the steps of: (i) performing web categorization; (ii) performing metadata collection; (iii) performing cross-platform correlation; and (iv) determining platform content moderation flag(s). In some examples, the CIS 106 may access one or more third-party(ies) 308 (e.g., website(s), social media platform(s), cloud service(s), etc.) when performing the process.

As described above, performing web categorization may include categorizing the content of the sites where the image was found during reverse image search. In some examples, the CIS 106 may utilize other services of a service provider (e.g., such as Cisco's TALOS, etc.) when performing the web categorization. As an example, a result of the set returned from 5A may include “AMC.com.” The system may perform web categorization to determine one or more categorizations of the image on amc.com. There may be a single categorization or multiple categorizations associated with the image. Examples of different types of categorizations: content categorization (social network; where it is from); threat categorization (not phishing website; not malicious website); URL reputation (good/positive; negative). In some examples, web categorizations may include content categorization associated with a particular social media platform (e.g., such as reddit.com) and one or more sub-web categorizations (e.g., categorization of a specific forum where the image is posted—e.g., adult forum, movie forum, etc.) within the social media platform. performing metadata collection may include capturing metadata information associated with the image on social media and websites. This may include extracting one or more of caption and alternative text in the image, hashtags associated with the image, user comments and/or reactions to the image. Capturing the metadata information may further include extracting information about the platform and/or website, communities where the images are shared/used, extracting information pertaining to current events/news associated with the image. The captured metadata information may be used by the system to determine an overall sentiment associated with the image (e.g., how people are reacting to it; what are the comments? How have people intended to use the image (positive or negatively)?), such as part of text analysis 312. In some examples, performing cross-platform correlation may include comparing how the same image is being shared across different platforms/websites and in what context. For instance, the system may determine that some metadata associated with the image comes from website A and other metadata is from website B. The system may correlate the metadata, such that the CIS 106 can determine how the image is being used across the different site(s) (e.g., such as when performing text analysis, as described herein).

In some examples, determining platform content moderation flag(s) may include determining if the image has been flagged, reported or removed from any of the result(s). For instance, some platforms or websites may utilize security flags and/or may implement different levels of content moderation. Content moderation used by different services can vary and have different levels. Additionally, some platforms or websites may tag an image according to its own particular set of moderation rules. Thus, tags and/or what content is moderated can differ based on the platform/policies. As an example, “abc.com” may have a very high content moderation policy and/or may provide an alert that may saying “this is a sensitive image, if you want to open it, click on it.” Thus, in this example, the website may provide advanced warning of images or content the website has tagged as “sensitive”. Accordingly, the system can extract and use the metadata including the “verdicts” from different platforms/website(s) to see how different platforms tag and/or classify the image.

At “5”, the CIS 106 may perform image analysis 310 of the image to generate image metadata. Image analysis 310 may comprise one or more of (i) performing Computer Vision (CV) and/or Deep Learning to generate metadata for the image, such as: to extract visual features, identify objects, faces and/or other key elements and/or (ii) performing Optical Character Recognition (OCR) in order to detect and extract text embedded in the image. For instance, the CIS 106 may generate image metadata using image analysis component, as described herein.

At “6”, the CIS 106 may perform text analysis 312 of the image to generate text metadata. Text analysis 312 may comprise applying NLP to the contextual metadata and image metadata in order to generate the text metadata (e.g., identifying sentiments, themes, etc.).

At “7”, the CIS 106 may generate a judgement, such as judgement 314 described herein. In some examples, the CIS 106 may utilize judgement component 114 to generate judgement, as described herein.

At “8”, the CIS 106 and/or gateway 326 may determine and/or identify whether a policy 316 of the service 104 applies to the data 324. For instance, the CIS 106 may determine whether to apply a security policy based on one or more of the categorization(s), classification(s), etc. included in the judgement and may output the judgement and the policy to apply to the gateway 326. In some examples, the gateway 326 may receive the judgement from the CIS 106 and may determine whether to apply a policy 316 after receiving the judgement.

At “9A”, the gateway 326 may perform an action on the data 324 that enables the data to be sent to an end user device. For instance, the gateway 326 may determine the image and/or data 324 can be sent (e.g., is not harmful and/or sensitive, and/or a policy allows the image to be sent) and may apply an action on the data 324 prior to sending. For instance, the gateway may strip the image from the data 324, strip text data from the image, add a warning or notification to the image, and/or perform any other action with regard to the data 324.

At “9B”, the gateway 326 may perform an action on the data 324 based on determining that the image violates a policy. In this example, the gateway 326 may determine that the image classification and/or categorizations are not permitted to be sent according to the policy and may drop the message and/or block the message from being sent.

As noted above, the system may also store the categorizations and/or classifications in the datastore 118. Accordingly, when a second image is sent by another application within the network, the other application may provide the second image to the service 104 and/or CIS 106. For instance, in some examples, the CIS 106 and/or datastore 118 may be implemented separately from the service 104. In some examples, the service 104 may be implemented separately from an application (e.g., such as application(s) 126). In this example, the second image may comprise the same image as the image in system 300B. The CIS 106 may perform step “1” as described herein using the memory component 108 and may perform an action on the second image at the second service according to the tag(s) and associated metadata stored for the image. Thus, the techniques described herein may use the tag(s) to block inappropriate or insensitive images across service(s) 104 (e.g., such as across different applications like email, chat etc.).

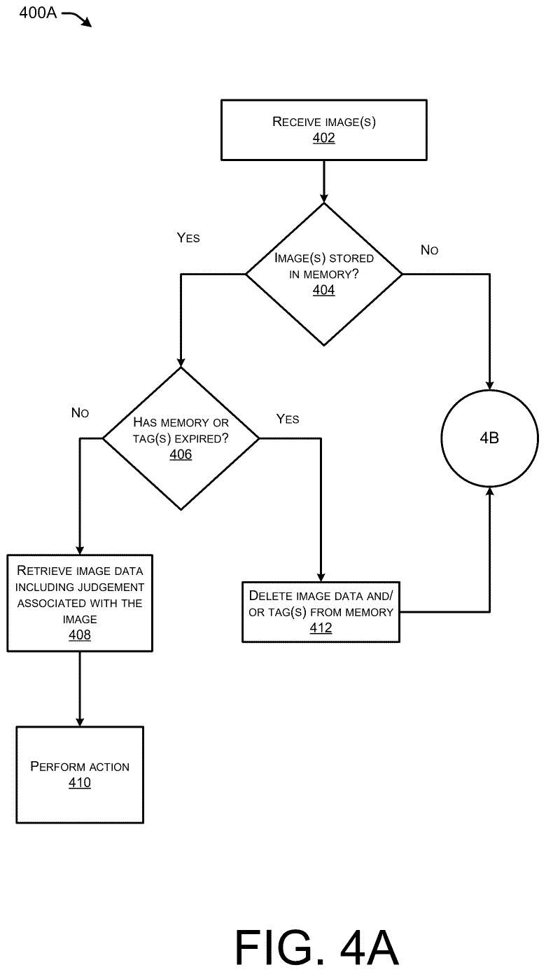

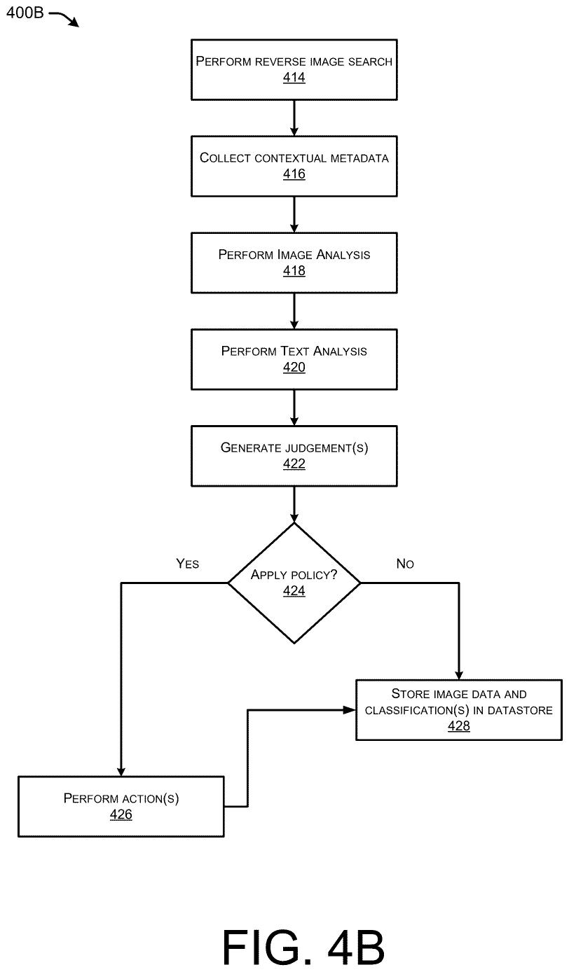

FIG. 4A illustrates a flow diagram of an example system 400A for identifying tag(s) and image data in memory, according to the techniques described herein. In some instances, one or more of the steps of system 400A may be performed by one or more devices (e.g., CIS 106, service(s) 104, etc.) that include one or more processors and one or more non-transitory computer-readable media storing computer-executable instructions that, when executed by the one or more processors, cause the one or more processors to perform operations of system 400A.

For instance, the system 400A may correspond to a process performed by the memory component 108, according to techniques described herein. As noted above, the system may store the categorizations and/or classifications in the datastore 118. Accordingly, when image(s) are sent by other application(s) within the network, the other application(s) may provide the image(s) to the service 104 and/or CIS 106. For instance, in some examples, the CIS 106 and/or datastore 118 may be implemented separately from the service 104. In some examples, the service 104 may be implemented separately from an application (e.g., such as application(s) 126). The CIS 106 may determine that the image(s) have previously been sent by the same application and/or a different application. Thus, the techniques described herein may use the tag(s) to block inappropriate or insensitive images across service(s) 104 (e.g., such as across different applications like email, chat etc.).

At 402, the system 400A may receive an image. For instance, the system 400A may receive an image as input from one or more of a content scanner, gateway, server, and/or any other component of a security service or other service of a network.

At 404, the system 400A may determine whether the image is stored in memory. For instance, the system 400A may determine whether the image and/or a tag associated with the image is stored in a datastore 118 (e.g., a cache). Thus, the system 400A may determine whether the image has been previously classified and/or tagged by the CIS 106.

Where the system determines the image is not stored in memory (404—NO), the process proceeds to FIG. 4B. Where the system determines the image is stored in memory (404—YES), the process proceeds to 406.

At 406, the system 400A may determine whether the memory has expired. In some examples, the system may additionally or alternatively determine whether a tag associated with the image has expired. For instance, the system 400A may determine whether a period of time (hours, days, weeks, or any other suitable period of time) as elapsed. The period of time may be predetermined and/or set in association with tag(s) and/or the memory as a whole.

Where the system 400A determines the memory has not expired (406—NO), the process proceeds to 408. At 408, the system 400A may retrieve image data including a judgement associated with the image. For instance, the image data may comprise the tag(s) associated with the image and/or metadata associated with the image. As described herein, the tag(s) may comprise one or more categorization(s) and/or classification(s) of the image. In some examples, the tag(s) may further indicate a score associated with each categorization and/or classification. For instance, where an image is classified as containing “adult” content, the system 400A may further indicate a score (e.g., ranging from 0-5 or any other suitable scale) that indicates how much “adult” content the image contains. For instance, an image comprising a tree with suggestive text may be classified as adult with a score that is different from an image comprising humans with the same suggestive text.

At 410, the system may perform an action. For instance, the system 400A may determine a policy to apply to the image based on the tag(s), score(s), etc. For instance, a policy may indicate that the system 400A drop a message, strip an image, and/or add a warning to an image tagged as “adult” and/or tagged as “adult” and having a score above a threshold (e.g., 3 or higher).

Where the system 400A determines the memory has expired (406—YES), the process proceeds to 412. At 412, the system 400A may delete image data from memory. In some examples, the system 400A may delete the image data associated with a particular image (e.g., such as where the image tag has expired). In some examples, the system 400A may additionally or alternatively delete all image data stored in the memory (e.g., empty the cache). The system may then proceed to FIG. 4B.

FIG. 4B illustrates a flow diagram of an example system 400B for detecting and classifying image(s) using context data, according to the techniques described herein. In some instances, one or more of the steps of system 400B may be performed by one or more devices (e.g., CIS 106, network device(s), service 104, etc.) that include one or more processors and one or more non-transitory computer-readable media storing computer-executable instructions that, when executed by the one or more processors, cause the one or more processors to perform operations of system 400B.

At 414, the system 400B may perform a reverse image search. For instance, the system 400B may perform a reverse image search using contextual metadata component 110, as described herein.

At 416, the system 400B may collect context metadata. For instance, the system 400B may collect the context metadata using contextual metadata component 110 (e.g., such as by performing contextual metadata process), as described herein.

At 418, the system 400B may perform image analysis. For instance, the system 400B may perform the image analysis using the image and text analysis component 112, as described herein.

At 420, the system 400B may perform text analysis. For instance, the system 400B may perform the text analysis using the image and text analysis component 112, as described herein.

At 422, the system 400B may generate judgement(s). For instance, the system 400B may generate judgement(s) 314 using the judgement component 114, as described herein. In some examples, the judgement(s) 314 may comprise image data, including tag(s) associated with the image and/or metadata associated with the image. As described herein, the tag(s) may comprise one or more categorization(s) and/or classification(s) of the image. In some examples, the tag(s) may further indicate a score associated with each categorization and/or classification. For instance, where an image is classified as containing “adult” content, the system 400A may further indicate a score (e.g., ranging from 0-5 or any other suitable scale) that indicates how much “adult” content the image contains. For instance, an image comprising a tree with suggestive text may be classified as adult with a score that is different from an image comprising humans with the same suggestive text.

At 424, the system 400B may determine whether to apply a policy. For instance, the system 400A may determine a policy to apply to the image based on the tag(s), score(s), etc. For instance, a policy may indicate that the system 400A drop a message, strip an image, and/or add a warning to an image tagged as “adult” and/or tagged as “adult” and having a score above a threshold (e.g., 3 or higher).

Where the system 400B determines to apply a policy (424-YES), the system 400B may proceed to 426. At 426, the system 400B may perform action(s). For instance, the system 400B may perform the action indicated by the policy.

Where the system 400B determines not to apply a policy (424-No), the system 400B may proceed to 428.

At 428, the system 400B may store image data and classification(s) in datastore. For instance, the system 400B may store the judgement 314, including the image data (e.g., such as the tag(s)) in a datastore 118 using memory component 108.

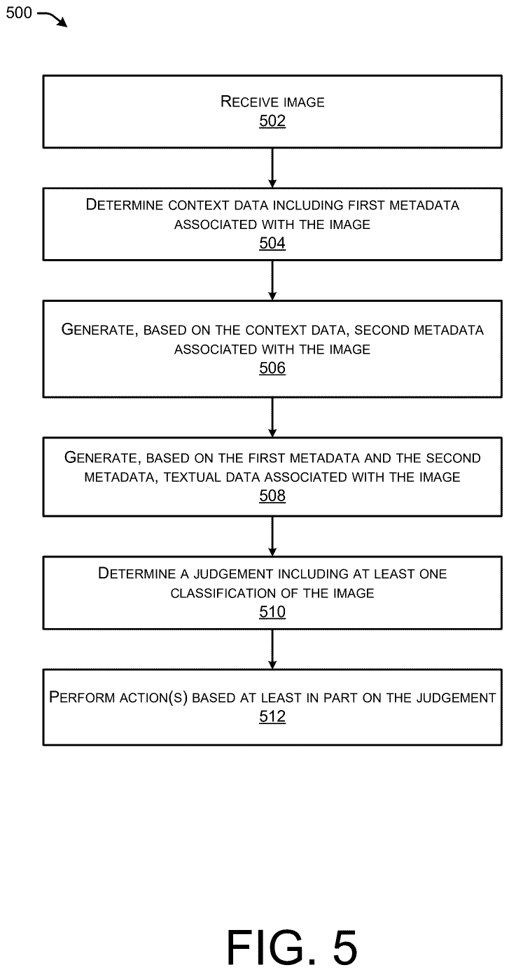

FIG. 5 illustrates a flow diagram of an example system 500 for providing a multi-layer context image scanner, according to the techniques described herein. In some instances, one or more of the steps of system 500 may be performed by one or more devices (e.g., CIS 106, service 104, etc.) that include one or more processors and one or more non-transitory computer-readable media storing computer-executable instructions that, when executed by the one or more processors, cause the one or more processors to perform operations of system 500.

At 502, the system may receive an image. In some examples, the system may receive the image from one or more of a content scanner, a server, a gateway, an API, or any other component of a system.

At 504, the system may determine context data including first metadata associated with the image. In some examples, the context data may include one or more of wherein the context data includes one or more of: uniform resource locators associated with one or more websites or social media sites; metadata information associated with the image on each of the one or more websites or the social media sites, the metadata information including caption metadata, alternative text metadata, hashtag metadata, user comment metadata, user reaction metadata, current event metadata, group metadata, sub-group metadata; cross platform correlation data; and/or content moderation data. In some examples, the context data may comprise contextual metadata generated by the contextual metadata component 110, as described herein.

At 506, the system may generate, based on the context data, second metadata associated with the image. In some examples, the system may generate the second metadata using image and text analysis component 112. For instance, generating the second metadata comprises performing one or more of computer vision, deep learning, or optical character recognition on the image, the second metadata comprising extracted visual feature metadata, object metadata, facial metadata, embedded text metadata, or other element metadata.

At 508, the system may generate, based on the first metadata and the second metadata, textual data associated with the image. For instance, the system may generate the textual data using image and text analysis component 112. In some examples, generating the textual data comprises applying a natural language processing to the first metadata and the second metadata. In some examples, the textual data comprises indications of sentiments or themes associated with an image across different website(s) and/or social media platform(s).

At 510, the system may determine a judgement including at least one classification of the image. In some examples, the system may determine the judgement using judgement component 114. In some examples, determining the judgement comprises utilizing at least one of a machine learning algorithm or a set of rules configured to be dynamically pushed to the image scanner. For instance, the machine learning algorithm may comprise a LLM specially trained to classify images with a high accuracy.

At 512, the system may perform action(s) based at least in part on the judgement. In some examples, the action(s) may be performed by action component 116. In some examples, the action(s) may be further based on a policy. In some examples, performing the action further comprises: determining, based on the judgement, a policy action; and performing, based on the policy action, the action, wherein the action comprises dropping a communication that includes the image or allowing the image to be sent via the network.

In some examples, the system may include tagging, by the image scanner, the image with an indication of the at least one classification; and storing, by the image scanner and in a datastore associated with the image scanner, the image and the judgement. For instance, the datastore may comprise a cache storage configured to store the image and associated tags for a period of time. In some examples, the datastore is further configured to store one or more of the context data, the first metadata, the second metadata, and the textual data in association with the image. In an example, the system may receive, by the image scanner, a second image; determine, by the image scanner, that the second image is stored in the datastore; and based on determining that a period of time associated with the datastore has not expired, perform the action based on a second judgement stored in the datastore in association with the second image.

In some examples, the system may include receiving, by the image scanner, a second image; determining, by the image scanner, that the second image is stored in the datastore; and based on determining that a period of time associated with the datastore has expired: collecting, by the image scanner, second context data including third metadata associated with the second image; generating, by the image scanner and based on the second context data, fourth metadata associated with the second image; generating, by the image scanner and based on the third metadata and the fourth metadata, second textual data associated with the second image; determining, by the image scanner and based on the second context data, fourth metadata, and textual data, a second judgement including at least one classification of the second image; performing an action based at least in part on the second judgement; and storing, in the datastore, the image and the second judgement.

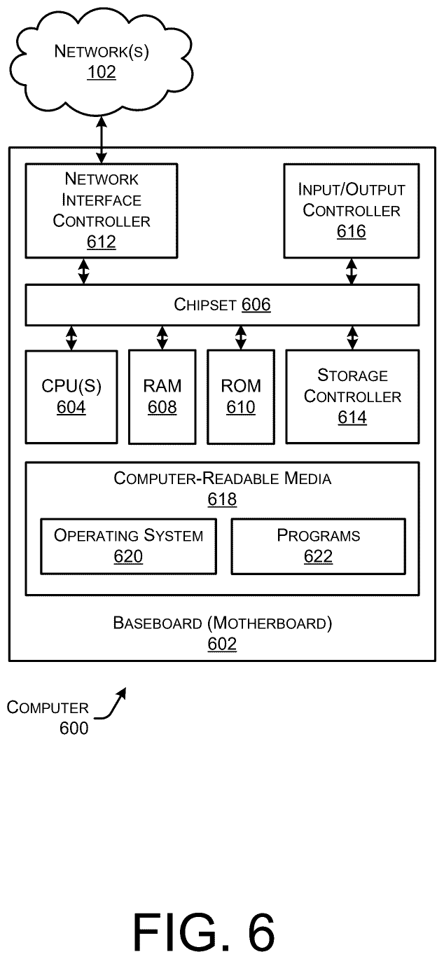

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a CIS 106 and/or any other device described herein, and may comprise personal devices (e.g., smartphones, tables, wearable devices, laptop devices, etc.), networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network 102. The chipset 606 can include functionality for providing network connectivity through a NIC 612, such as a gigabit Ethernet adapter. The NIC 612 is capable of connecting the computer 600 to other computing devices over the network 102. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the CIS 106 and/or any components included therein, may be supported by one or more devices similar to computer 600. Stated otherwise, some or all of the operations performed by the CIS 106 and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a CIS 106 and/or any other device. The computer 600 may include one or more hardware processors (e.g., processors such as CPUs 604) configured to execute one or more stored instructions. The processor(s) may comprise one or more cores. Further, the computer 600 may include one or more network interfaces configured to provide communications between the computer 600 and other devices, such as the communications described herein as being performed by the CIS 106 and/or any other device. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure. For instance, the programs 622 may cause the computer 600 to perform techniques including receiving an image received by an application within a network; determining context data including first metadata associated with the image; generating, by the image scanner and based on the context data, second metadata associated with the image; generating, based on the first metadata and the second metadata, textual data associated with the image; determining, based on the context data, the second metadata, and the textual data, a judgement including at least one classification of the image; and performing an action based at least in part on the judgement.

In this way, the computer 600 may provide a multi-layered contextual image scanner (CIS) that integrates images recognition with social media websites and internet context. By utilizing context, the system may improve accuracy of image categorization(s) and classification(s), leading to a reduction in false positive(s) across different categories (e.g., malicious, benign, etc.) and/or classification(s) (e.g., adult, spoof, medical, violence, racial, etc.). Further, by reducing false positive(s) (e.g., categorizing an image as malicious or harmful when it may not be) and reducing incorrect classification(s), the system may improve the amount of true positive(s) that are identified. Further, given the system may be integrated and deployed as part of a cloud service, within an enterprise network, and/or run on hardware of a network device, the system is highly scalable and may be implemented by any service that utilizes an image scanner. The system may reduce computing resources required by reducing false positives, thereby enabling traditional image categories and/or classification(s) to extend and/or include additional categories.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, by an image scanner, an image received by an application within a network;
determining, by the image scanner, context data including first metadata associated with the image;
generating, by the image scanner and based on the context data, second metadata associated with the image;
generating, by the image scanner and based on the first metadata and the second metadata, textual data associated with the image;
determining, by the image scanner and based on the context data, the second metadata, and the textual data, a judgement including at least one classification of the image; and
performing an action based at least in part on the judgement.

2. The method of claim 1, wherein performing the action further comprises:
determining, based on the judgement, a policy action; and
performing, based on the policy action, the action, wherein the action comprises dropping a communication that includes the image or allowing the image to be sent via the network.

3. The method of claim 1, further comprising:
tagging, by the image scanner, the image with an indication of the at least one classification; and
storing, by the image scanner and in a datastore associated with the image scanner, the image and the judgement.

4. The method of claim 3, wherein the datastore comprises a cache storage configured to store the image and associated tags for a period of time.

5. The method of claim 3, wherein the datastore is further configured to store one or more of the context data, the first metadata, the second metadata, and the textual data in association with the image.

6. The method of claim 3, further comprising:
receiving, by the image scanner, a second image;
determining, by the image scanner, that the second image is stored in the datastore; and
based on determining that a period of time associated with the datastore has not expired, performing the action based on a second judgement stored in the datastore in association with the second image.

7. The method of claim 3, further comprising:
receiving, by the image scanner, a second image;
determining, by the image scanner, that the second image is stored in the datastore; and
based on determining that a period of time associated with the datastore has expired:
collecting, by the image scanner, second context data including third metadata associated with the second image;
generating, by the image scanner and based on the second context data, fourth metadata associated with the second image;
generating, by the image scanner and based on the third metadata and the fourth metadata, second textual data associated with the second image;
determining, by the image scanner and based on the second context data, fourth metadata, and textual data, a second judgement including at least one classification of the second image;
performing an action based at least in part on the second judgement; and
storing, in the datastore, the image and the second judgement.

8. The method of claim 1, wherein the context data includes one or more of:
uniform resource locators associated with one or more websites or social media sites;
metadata information associated with the image on each of the one or more websites or the social media sites, the metadata information including caption metadata, alternative text metadata, hashtag metadata, user comment metadata, user reaction metadata, current event metadata, group metadata, sub-group metadata;
cross platform correlation data; and
content moderation data.

9. The method of claim 1, wherein generating the second metadata comprises performing one or more of computer vision, deep learning, or optical character recognition on the image, the second metadata comprising extracted visual feature metadata, object metadata, facial metadata, embedded text metadata, or other element metadata.

10. The method of claim 1, wherein generating the textual data comprises applying a natural language processing to the first metadata and the second metadata.

11. The method of claim 1, wherein determining the judgement comprises utilizing at least one of a machine learning algorithm or a set of rules configured to be dynamically pushed to the image scanner.

12. A system comprising:
one or more processors; and
one or more non-transitory computer-readable media that, when executed by the one or more processors, cause the one or more processors to perform operations comprising:
receiving an image sent within a network;
collecting context data including first metadata associated with the image;
generating, based on the context data, second metadata associated with the image;
generating, based on the first metadata and the second metadata, textual data associated with the image;
determining, based on the context data, second metadata, and textual data, a judgement including at least one classification of the image; and
performing an action based at least in part on the judgement.

13. The system of claim 12, wherein the context data includes one or more of:
uniform resource locators associated with one or more websites or social media sites;
metadata information associated with the image on each of the one or more websites or the social media sites, the metadata information including caption metadata, alternative text metadata, hashtag metadata, user comment metadata, user reaction metadata, current event metadata, group metadata, sub-group metadata;
cross platform correlation data; and
content moderation data.

14. The system of claim 12, wherein generating the second metadata comprises performing one or more of computer vision, deep learning, or optical character recognition on the image, the second metadata comprising extracted visual feature metadata, object metadata, facial metadata, embedded text metadata, or other element metadata.

15. The system of claim 12, wherein generating the textual data comprises applying a natural language processing to the first metadata and the second metadata.

16. The system of claim 12, wherein performing the action further comprises:
determining, based on the judgement, a policy action; and
performing, based on the policy action, the action, wherein the action comprises dropping a communication that includes the image or allowing the image to be sent via the network.

17. The system of claim 12, the operations further comprising:
tagging the image with an indication of the at least one classification; and
storing, in a datastore, the image and the judgement.

18. The system of claim 17, wherein the datastore comprises a cache storage configured to store the image and associated tags for a period of time.

19. The system of claim 17, wherein the datastore is further configured to store one or more of the context data, the first metadata, the second metadata, and the textual data in association with the image.

20. One or more non-transitory computer-readable media storing instructions executable by one or more processors of a node, wherein the instructions, when executed, cause the one or more processors to perform operations comprising:
receiving an image sent within a network;
collecting context data including first metadata associated with the image;
generating, based on the context data, second metadata associated with the image;
generating, based on the first metadata and the second metadata, textual data associated with the image;
determining, based on the context data, second metadata, and textual data, a judgement including at least one classification of the image; and
performing an action based at least in part on the judgement.
